(19) United States
(12) Patent Application Publication
(10) Pub. No.: US 2024/0142656 A1
(43) Pub. Date: May 2, 2024

(54) METHOD FOR DETECTION OF UNDERGROUND OBJECTS

(71) Applicants: Reuven ZEMACH, Petach Tikvah (IL); Motti HARIDIM, Givat Zeev (IL)

(72) Inventors: Reuven ZEMACH, Petach Tikvah (IL); Motti HARIDIM, Givat Zeev (IL)

(21) Appl. No.: 18/272,089

(22) PCT Filed: Jan. 11, 2022
(86) PCT No.: PCT/IL2022/050042

§ 371 Date: Jul. 12, 2023

Related U.S. Application Data
(60) Provisional application No. 63/136,923, filed on Jan. 13, 2021.

(51) Int. Cl. G01V 3/38; G01S 7/41; G01S 13/10; G01S 13/88; G01V 3/17

(52) U.S. Cl. CPC G01V 3/38; G01S 7/411; G01S 13/10; G01S 13/885; G01V 3/17

(57) ABSTRACT

The present invention provides systems and methods for detecting an underground object, the method including applying a ground penetrating radar/electromagnetic wave signals to a location of interest into a ground surface, detecting outputted electromagnetic wave signals over time and space from the location of interest, processing the electromagnetic wave signals over time and space to produce raw data output, manipulating the raw data output to detect the object.

### FIELD OF THE INVENTION

The present invention relates generally to objects detection and localization methods and systems, and more specifically to methods and apparatus for detection and allocation of underground objects in location (space positioning) and depth (by Electromagnetic waves time travel in media).

### BACKGROUND OF THE INVENTION

Ground Penetrating Radar (GPR) is applied to many areas of underground mapping and research in diverse fields, such as geology, mining, archeology, agriculture, civil engineering, military and so on. GPR is widely used to locate underground metallic and non-metallic objects, such as rocks, artifacts, public facilities, landmines, ground water, ores, minerals, tunnels and others and provides underground mapping. Numerous methods, experimental and computational, have been developed to improve its performance.

In applications requiring high sensitivity and high resolution, in many methods results are indecisive, or may give inaccurate results which call for enhancement of the findings, or in certain cases it totally fails to detect the target objects. There thus remains an unmet need to provide improved GPR systems and GPR methods of underground mapping to allow for general purpose tools for objects allocation results with higher level of findings.

### SUMMARY OF THE INVENTION

It is an object of some aspects of the present invention to provide improved systems and GPR methods of applying GPR to detect underground objects.

In some embodiments of the present invention, improved methods and apparatus are provided for detecting underground or underwater objects.

In other embodiments of the present invention, a method and system are described for locating underground or underwater objects.

In further embodiments of the present invention, a method and system are described for determining a type of an underground or underwater object, such as ore layers.

In additional embodiments for the present invention, a novel system and method are provided for processing GPR signals to detect and locate an underground object.

The present invention provides systems and methods for detecting an underground object, the method including applying a ground penetrating radar that transmits electromagnetic wave signals (short pulses) into the underground layers at location of interest, receives the electromagnetic wave signals reflected from various objects (both desired and undesired (spurious signals)), records the received signals over time and space to produce raw data output, and analyzing and manipulating the raw data output to detect and locate the objects. The transmitter and receiver (including the antennas) may be moving on the surface of the target area in order to scan the desired area (a straight one-dimensional line, known as B-Scan, or two-dimensional area by multiple B-scans, known as C-scan). In this case the recorded data corresponds to signals collected along space and time. In the case of a single A-scan measurement, the transmitter and receiver are at a stationary position so that the recorded data is a function of time only for the given location.

Using the methods presented in this invention, underground mapping, detection/finding, and locating of underground objects are significantly improved, in terms of detection probability and locating accuracy

The present invention provides systems and methods for detecting underground objects (including finding the location of each object) under harsh conditions. That is, when the target object is small, non-metallic and GPR is not placed directly on the ground surface, or in complex underground, e.g. scanning tunnels, caves and so on, or installed on a flying drone. The methods of the present invention may be applied to both civilian applications and military uses.

The systems, apparatus and methods of the present invention enable GPR to provide at least one or all of the following advantages:
a) Higher detectivity;
b) Lower false alarm rate;
c) Higher lateral resolution;
d) Higher vertical resolution;
e) Capability to detect small objects;
f) Capability to detect non-metallic (e.g. plastic) objects; and
g) Capability of working from ground, underground and from above ground (e.g. flying drones).

Some of the systems, apparatus and methods of the present invention enable GPR to provide all of the following advantages:
a) Higher detection rates;
b) Lower false alarm rate;
c) Higher lateral resolution;
d) Capability to detect non-metallic (e.g. plastic) objects; and
e) Capability of working from ground, underground and from above ground e.g. flying drones.

There is thus provided according to an embodiment of the present invention, a system for detecting an underground object, the system comprising:
a) a signal (electromagnetic (EM) pulse) generator;
b) a transmitter and a transmitting (Tx) antenna for transmitting the signal, in frequencies of choice, in various modes, forms, modulation methods, wavelets and otherwise, incident into the targeted ground;
c) a receiver and a receiving (Rx) antenna;
d) a data collector for collecting incoming signals from the receive antenna comprising at least one of a B-scan and C-scan raw data over space and time; and
e) a processor adapted to perform at least one or all of the following:
   i. organize raw data input to statistic space ensembles and time ensembles;
   ii. formulate and create space and time ensembles correlation functions SECFs and TECFs, respectively;
   iii. calculate space ensembles correlation functions SECFs and time ensembles correlation functions TECFs;
   iv. process SECFs and TECFs to produce output matrices for adjacent vectors, that is, data's n=1 one vector apart;
   v. repeat iv for n>1 several vectors apart and
   vi. check results of SECFs and TECFs matrices by testing their functions change, applying several various vectors apart in correlations computations observing the changes in the dips' levels in their graphs (or otherwise), which operate as sensitivity tool in objects findings. This property is defined hereafter as Functions Change Sensitivity Method (FCSM).
   vii. make figures of SEFFs and TECFs as functions of space and time, respectively, to examine reduction/drops/dips (local minima) in these functions indicative of the presence of any discontinuity in the underground due to presence of an object or change in the content of the layer (e.g. sand, clay, silt, granite, limestone, shale, ore, minerals etc.),
   whereby the system is configured to detect the underground object/layers (e.g. sand, clay, silt, granite, limestone, shale, ore, etc.).

There is thus provided according to an embodiment of the present invention, a GPR scanning system and method for detecting an underground object, the system comprising:
a) a signal generator;
b) a transmitter and a transmitting (Tx) antenna for generating electromagnetic (EM) waves, in frequencies of choice, in various modes, forms, wavelets and otherwise, transmitted into the targeted ground;
c) a receiving (Rx) antenna and a receiver; and
d) a data collector for collecting incoming electromagnetic (EM) waves signals comprising at least one of a B -scan and C-scan raw data over a function of space and time;
   wherein a mid-point between said transmission antenna and said receiving antenna, of a scanning system remains at a fixed point.

There is thus provided according to another embodiment of the present invention, a GPR scanning system for detecting an underground object, the system comprising:
a) a signal generator;
b) a transmitting(Tx) antenna for generating electromagnetic (EM) waves, in frequencies of choice, in various modes, forms, wavelets and otherwise, transmitted into the targeted ground;
c) a receiving (Rx) antenna and a receiver; and
d) a data collector for collecting incoming electromagnetic (EM) waves signals comprising at least one of a B-scan and C-scan raw data over a function of space and time;
   wherein a distance between said transmission antenna and said receiving antenna of a scanning system remains fixed.

There is thus provided according to another embodiment of the present invention, a system for detecting a type of an underground object, the system comprising:
a) a signal generator;
b) a transmitting (Tx) antenna for generating electromagnetic (EM) waves, in frequencies of choice, in various modes, forms, wavelets and otherwise, transmitted into the targeted ground;
c) a receiving (Rx) antenna and a receiver; and
d) a data collector for collecting incoming electromagnetic (EM) waves signals comprising at least one of a B-scan and C-scan raw data over a function of space and time;
   wherein a distance between said transmission antenna and said receiving antenna of a scanning system changes up to a pre-defined desired controlled setting.

There is thus provided according to another embodiment of the present invention, a method for detecting at least one underground object, the method comprising:
a) applying a ground penetrating radar (electromagnetic wave) signal to a location of interest into a ground surface;
b) detecting outputted electromagnetic wave signals over time and space from said location of interest; that is signal reflected back from various underground objects and discontinuities and received by the Rx antenna
c) processing said electromagnetic wave signals over time and space comprising at least one of:
   i. organizing raw data input to statistic space ensembles and time ensembles;
   ii. formulating space and time ensembles correlation functions, referred to as SECF sand TECFs, respectively;
   iii. calculating space and time ensembles correlation functions SECFs and TECFs;
   iv. processing SECFs and TECFs to produce output matrices for adjacent vectors, that is, data's n=1 one vector apart
   v. processing SECFs and TECFs to produce output matrices for n>1 for several vectors apart between adjacent vectors; and
   vi. checking results of SECFs and TECFs matrices by Change Sensitivity Method for Functions Change Sensitivity Method (FCSM) comprising increasing a number, n, of vectors apart, to produce increased processed data output,
      thereby enabling detection of the at least one object.

Additionally, according to an embodiment of the present invention, the present invention will be more fully understood from the following detailed description of the preferred embodiments thereof, taken together with the drawings.

### BRIEF DESCRIPTION OF THE DRAWINGS

The invention will now be described in connection with certain embodiments with reference to the following illustrative figures so that it may be more fully understood.

With specific reference now to the figures in detail, it is stressed that the particulars shown are by way of example and for purposes of illustrative discussion of the detailed embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified pictorial illustration of a system for detecting an underground object, in accordance with an embodiment of the present invention;

FIG. 1B is a simplified flow chart of a method for detecting an underground object, in accordance with an embodiment of the present invention;

FIG. 1C is a graph of a generalized output of a prior art method, measured, simulated, computed, theorized or otherwise, of raw data processing for detecting underground objects;

FIG. 2 is a simplified flow chart of a method of processing received data inputs in the method of FIG. 1B, in accordance with an embodiment of the present invention;

FIG. 3 is a simplified schematic illustration of a method for creating statistical ensembles in the method of FIG. 1B, in accordance with an embodiment of the present invention;

FIG. 4 comprises a set of illustrative graphs of SE (space ensembles) and time ensembles (TE) of received signal field strength against time, in the method of FIG. 1B, in accordance with an embodiment of the present invention; FIG. 5 is a graph of outputs of TECFs (Time Ensemble Correlation Functions) for a set of underground objects in an example of a model with 1-vector apart, in accordance with an embodiment of the present invention;

FIG. 6A-6F comprises a set of graphs of outputs of TECFs (Time Ensemble Correlation Functions) results for all allocated underground objects in an example of a model with 1-vector to 6-vectors apart between successive vectors, in accordance with an embodiment of the present invention;

FIG. 7A is a graph of outputs of SECFs (Space Ensemble Correlation Functions) results for an example model with 1-vector apart detecting EM time travel during path Tx-object-Rx for SE correlations at 1-vector apart, in accordance with an embodiment of the present invention;

FIG. 7B is a graph of outputs of SECFs (Space Ensemble Correlation Functions) results for an example base model with 3-vector apart detecting EM time travel during path Tx-object-Rx for SE detection enhancement between 1-vector apart, specifically enhancing item 707 in FIG. 7A to item 757 in FIG. 7B at 3-vectors apart, in accordance with an embodiment of the present invention;

FIG. 8A is a simplified graph of Stochastic Collocation of Time Ensemble (SC-TE) outputs at a first noise level and at a second noise level, to detect underground objects at a depth coordinate (m) wherein a source of noisy raw data is generated due to noise in scanning system, or in noise in the carrier of a scanning system, or unknown ground properties in GPR raw data simulations, computations, theorized or otherwise, in accordance with an embodiment of the present invention;

FIG. 8B is a simplified graph of Stochastic Collocation of Space Ensemble (SC-SE) outputs at a first noise level and at a second noise level, to detect underground objects at a time coordinate (nanoseconds), for objects depth calculations, wherein a source of noisy raw data is generated due to noise in scanning system, or in noise in the carrier of a scanning system, or unknown ground properties in GPR raw data simulations, computations, theorized or otherwise, in accordance with an embodiment of the present invention;

FIG. 9A is an output of TECFs between moving scans, at one vector apart used to detect experimentally measured physical non-metal underground objects in space/time, in accordance with an embodiment of the present invention;

FIG. 9B is an output of TECFs between moving scans, at two vectors apart used to detect experimentally measured physical metal underground objects in space/time, in accordance with an embodiment of the present invention; and

FIG. 9C is a simplified schematic illustration of objects placed underground in use in experiment of FIG. 9B, in accordance with embodiments of present invention.

### DETAILED DESCRIPTION OF THE EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

The present invention relates to ground penetrating antennas in general and in particular the use of GPR statistical methods for detection, localization and identification of the underground objects or the underlying ground contents and structures.

GPR System is a method for allocation of all types of underground objects or structures in measurements or simulations. GPR multiple A-scans, known as B-scan, are made physically by machines or by imitating simulations.

The machine or the imitating simulation or theoretical calculations or otherwise in 1-dimention includes:
(a) A pair of antennas:
   (1) a signal generator and a Tx antenna generating and transmitting electromagnetic (EM) waves, in frequencies of choice, into the targeted ground, and
   (2) a receiving antenna Rx and data collector registering the incoming electromagnetic (EM) waves signals.
   (3) raw data (B-scan or C-scan) is collected. This raw data is to be used in the methods of the present invention.

The machine or the imitating simulation or theoretical calculations or otherwise in 2-dimentions (or as collections of 1-dimentions) includes:
(a) A pair of antennas:
(1) a signal generator and transmit (Tx) antenna generating electromagnetic (EM) waves, in frequencies of choice, in various modes, forms, modulation methods, wavelets and otherwise, transmitted into the targeted ground,
(2) a receiving (Rx) antenna and data collector registering the incoming electromagnetic (EM) waves signals.
(3) B-scan and C-scan raw data is collected as a function of time and space. The raw data is to be used in the proposed method; and
(4) An apparatus for moving the antennas or the whole system, either in parallel when keeping the Tx-Rx antennas spacing constant or moving them one towards the other one in a manner that the mid-point between the 2 antennas remains at a fixed point and a signal recording and processing unit, or at any choice of form of Tx-Rx relative positioning scanning form in (1)-to-(4) items.

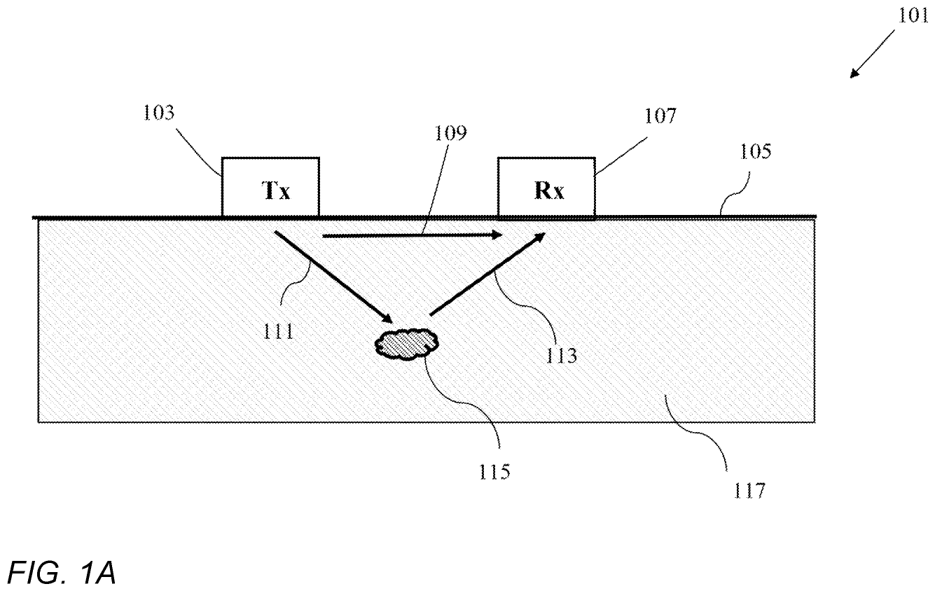

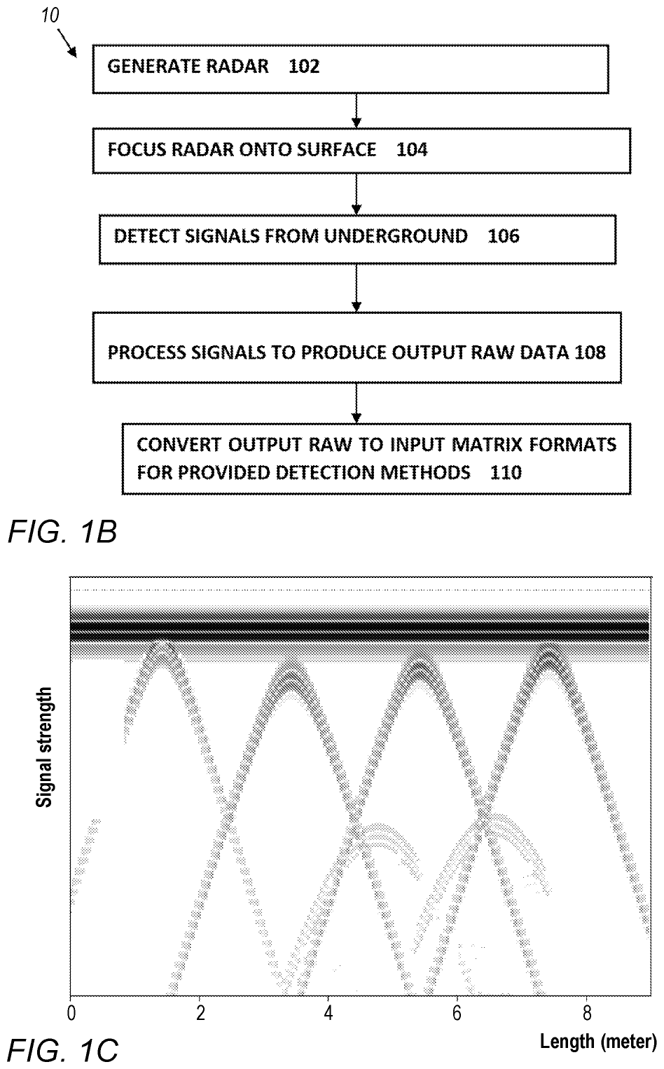

Reference is now made to FIG. 1A, which is a simplified pictorial illustration of a system 101 for detecting an underground object 115, in accordance with an embodiment of the present invention. System 101 comprises a signal (e.g. short pulse or otherwise) transmitter 103 consisting of a signal generator and an antenna element (not shown) and on ground surface 105 The operator moves the whole system along the path of interest on the ground surface. The transmitter element of 103 (not shown) transmits pulses onto the ground 105, such as short pulses at frequency of choice depending on ground properties, target of detection, depth of detection and so on, where frequencies of choice may be in the range of 10 MHz-4 GHz, or otherwise, for durations of pico-seconds, nano-seconds, or otherwise (depending of environment properties) or in continuous mode, into the ground 117 at an incidence angle theta degrees (0-45 degrees from the vertical). System 101 further comprises a receiver element 107, configured to receive reflected pulses 113 and a refracted (horizontal) signal 109 from the ground over time. The data received by 107 is then recorded and passed to a processing unit. The received signals are associated with the reflected signals from objects and ground discontinuities. These examples are to illustrate the systems and methods of the present invention, and should not be deemed limiting. Further examples appear in the references listed herein, incorporated herein by reference.

Some of the methods of the present invention are described in further detail in
Haridim, M., & Zemach, R. (2021). Stochastic Processes Approach in GPR Applications. IEEE Transactions on Geoscience and Remote Sensing. And in
Zemach, R., &Haridim, M. (2021). Stochastic collocation introduction into correlation functions method applied for underground objects detection. IEEE Transactions on Geoscience and Remote Sensing, both publications incorporated herein by reference.

Turning to FIG. 1B, there is seen a simplified flow chart 100 of a method for detecting an underground object, in accordance with an embodiment of the present invention.

In a generating radar step 102, a transmitter 103 of FIG. 1A is operative to generate and transmit radar pulses at frequency, intensity and duration depending on ground parameters, type of detection, and depth of scanning targets.

The user controls system 101 using the remote communication and controller apparatus (in some cases the controller is built-in to the system) to set the transmitter element at a predefined angle to the ground and focuses the radar onto the surface/ground in a focusing radar step 104 at an initial time zero (t₀)and initial distance zero (X₀).

After a time t₁ and/or distance X₁ from the initial set points, the user uses system 101 to detect reflected pulses/signals coming from under the surface/ground in a detecting step 106.

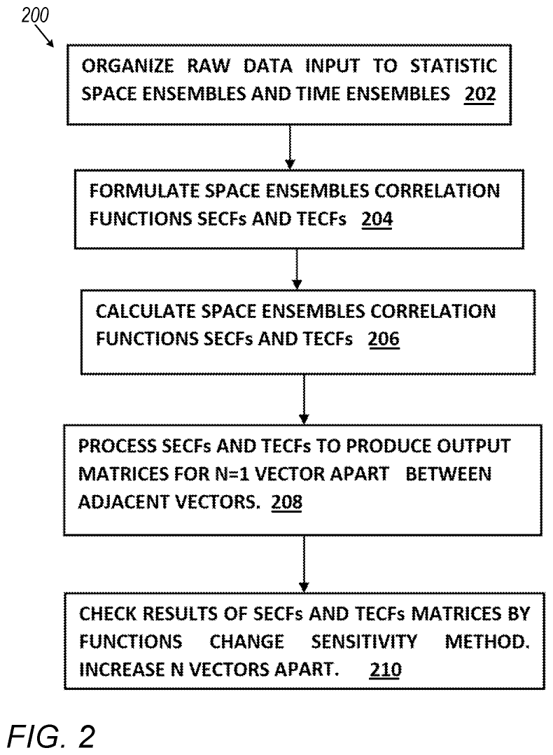

The user then applies system 101 to process the reflected pulses/signals in a signal processing step 108. More details of this signal processing step are provided in FIG. 2 and the description thereof.

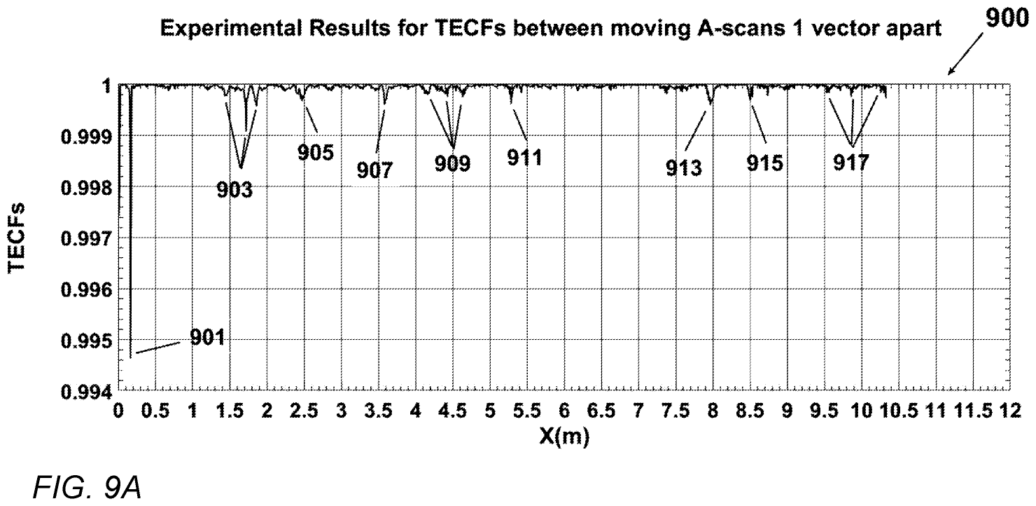

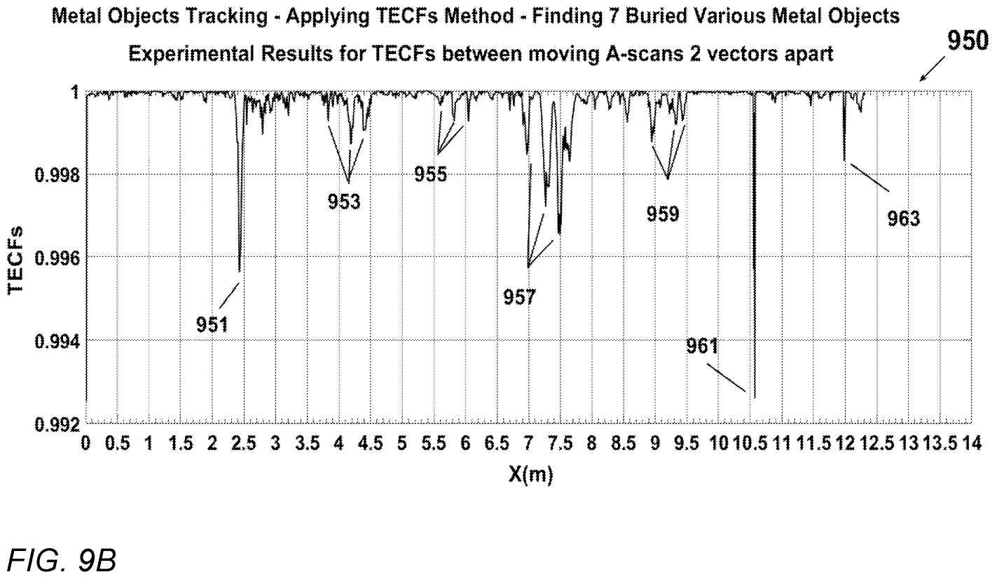

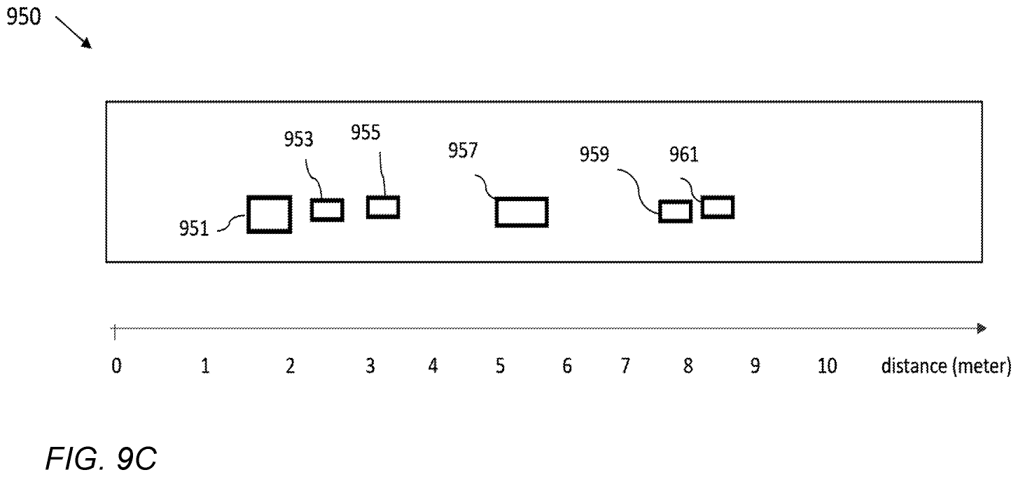

Once the signals are processed with a statistical analysis and/or any other analysis algorithm, data outputs and/or graphical outputs are generated leading to detecting of objects in an object(s) detecting step 110. One non-limiting example of object detection is shown in FIGS. 9A-9C herein below.

FIG. 1C is a graph of a generalized output of a prior art method, measured, simulated, computed, theorized or otherwise, of raw data processing for detecting underground objects

Reference is now made to FIG. 2, is a simplified flow chart of a method 200 of processing received and recorded raw data by the system of FIG. 1A, in accordance with an embodiment of the present invention.

In an organizing raw data step 202, raw data is organized to statistic space ensembles and statistic time ensembles. The recorded raw data from the receiving antenna is now organized as statistical vectors (random values) in two types of sequences, namely (1) space sequences (SE) corresponding to time encounter with an object enabling computation of the depth of the object from which the signal (pulse) is reflected and (2) time sequences (TE) corresponding to the distance along the B-scan straight line at which location in the underground the signal is reflected by the object.

In a formulating space and time ensembles' correlation functions step 204, space and time ensembles' correlation functions (SECFs, and TECFs) are formulated.

The correlation functions are defined using the time/space sequences of 202. Use the statistics built groups of SE and TE from the received raw matrix data; renormalize the Electromagnetic (EM) components' waves squared amplitude values to produce generalized SE and TE vectors S_{q}(tᵢ). Each line from the raw matrix data is renormalized to produce a generalized vector in the SE vectors ensemble. That is, the formation of Space Ensemble (SE) is made by grouping all EM generalized amplitudes at (xⱼ, zⱼ)j∈ [symbol] (1, 2, ine for some fixed t₁ by the following:

$$\{ {S}_{q}^{N} [ ( j , j ) ; {t}_{l} ] \} = \{ {S}_{q}^{N} [ ( j = 1 , j = 1 ) ; {t}_{l} ] , {S}_{q}^{N} [ ( j = 2 , j = 2 ) ; {t}_{l} ] , = {S}_{q}^{N} [ ( j = m , j = m ) ; {t}_{l} ] \}$$

Each column from the raw matrix data is renormalized to produce a generalized vector in the TE vectors ensemble. That is, the formation of Time Ensemble (TE) is made by grouping all tᵢ; i∈ [symbol] (1, 2, bn) by the following:

{S_{q}^{N}[(j, j); tᵢ]}={S_{q}^{N}[(j, j); t₁], S_{q}^{N}[(j, j); t₂], S_{q}^{N}[(j, j); t_{n]}}

In a Calculating Space and Time ensembles' correlation functions step 206, Space and Time ensembles' correlation functions (SECFs, and TECFs) are calculated.

Use of the SE and TE ensemble vectors from 204 to calculate from the weighted generalized vectors the statistic functions: expectation values Eⱼ{S_{q}^{N}[(j, j); i]}; the appropriate standard deviations σ_{S}(j, j; i), and Cov_{T}(j, j; i); the covariance functions Cov_{S}[S_{q}^{N}(j, j; i), S_{q}^{N}(j, j; i+l)] and Cov_{T}[S_{q}^{N}(j, j; i), S_{q}^{N}(j+p, j+p; i), from which the correlation functions SECFs ρ_{S} [symbol] (j, j; i):(j, j; i+l) [symbol] and TECFs ρ_{T} [symbol] (j, j; i):(j, j; i+p, j+p; i) [symbol] are calculated. These correlations can be calculated between immediate close adjacent vectors in each ensemble (that is one vector apart), or between several vectors apart, as may be required by the analysis of the raw data received.

In a processing SECFs AND TECFs to produce output matrices step 208 SECFs and TECFs are processed to produce output matrices for n=1 vector apart between adjacent vectors. Apply a method of step 206, a calculation of SECFs and TECFs is performed using GPR raw data input generated from any available source: such as, but not limited to, experimental, simulated or theoretical, to create Space Ensemble (SE) renormalized collective of SE vectors and to create Time Ensemble (TE) renormalized collective of TE vectors defined in step 204.

Generate appropriate computable algorithms that can be employed in a computing software/hardware machines, are configured and constructed to perform SECFs and TECFs calculations.

These may then be presented in output forms, graph, tables, documents to other machines, devices and alike, for analysis by the viewer. At this stage, computations are performed between each two adjacent vectors apart (namely for one vector apart), in SE vectors' group and TE vectors' group.

In checking results in step 210, the computations of SECFs and TECFs matrices start at 1 vector apart (n=1). Then, if required, computations are repeated with number of vectors apart increased to n>1 vectors' apart applying Functions Change Sensitivity Method (FCSM).

Applying step 208, computations for SECFs and TECFs derived for one vector apart mode, are performed between any two non-adjacent n-vectors apart (namely for n=2, 3, . . . vectors apart), in SE vectors' groups and TE vectors' group as a sensitivity tool to improve indications for object allocation. By expanding the computable algorithms in step 208, employing the computing software/hardware machines that can perform SECFs and TECFs calculations to include a sensitivity analysis tool that can be presented in output forms, graph, tables, documents to other machines, devices and alike, for analysis by the viewer, in a checking results step 210.

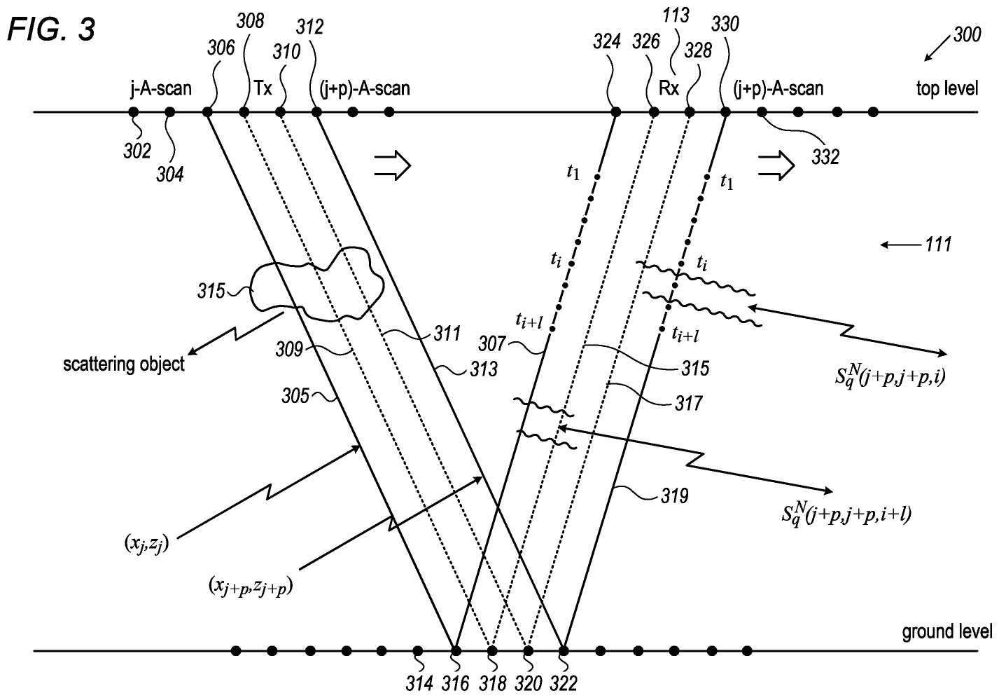

FIG. 3 is a simplified schematic illustration of a method for creating statistical ensembles of space ensemble SE and time ensemble in the method of FIG. 1B, in accordance with an embodiment of the present invention. TECFs SECFs are built up from the received signal in a multitude of A-scans forming a B-scan. The received pulses are indexed regularly as sequences of time and space.

In this scheme (300), a GPR machine is covering above ground a line of A-Scan sampling to collect GPR raw data. In this A-Scan, EM waves irradiated into the ground as successive sampling points, by 111, the transmitter Tx, at points 302 (the j sample example), 302, 306, 308, 310, 312 (the j+p sample example) etc., while 113 is the receiver Rx that collects these samples reflected from the ground at their corresponding points 324, 326, 328, 330, 332, etc. Tx (111) samples propagate EM waves via 305, 309, 311, and 313 etc. into the ground, and 307, 315, 317, 319 etc. are the reflected EM waves off the ground, collected by Rx (113) at the corresponding points. Schematic scattering object is presented by 315 which give rise to potential change in TECFs and SECFs values. The schematic bottom ground levels at which points of EM waves are reflected, in this A-Scan, are denoted by 314, 316, 318, 320, 320, 322, etc., in accordance with an embodiment of the present invention.

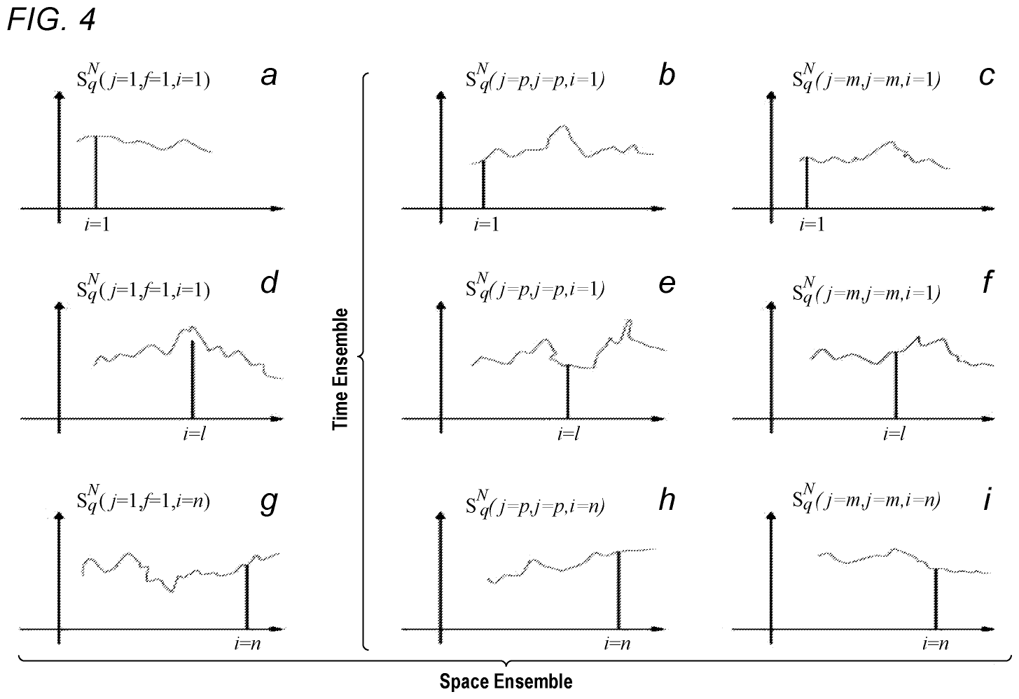

FIG. 4 comprises a set of graphs illustrating how signals transmitted and received from the same position (vertical columns with the same value of j) are received at various times corresponding to different values of i are samples and recorded for building the TE-Time Ensemble, enabling object location along the line of scan in A-scan, and how SE is built by the horizontal rows each corresponding to a different position (noted by j) at the same sampling time noted by index i for building the SE-Space Ensemble, enabling time encounter event of an object, that gives object depth in calculation at each point in the line of scan in A-scan.

In this scheme (400), a GPR raw data collected by GPR machine as in 300, or generated in simulation, theoretical computations or otherwise, denoted here as m×n M(GPR), is structured to create the Space Ensemble (SE) and the time ensemble (TE)

Creating SE:

A sequence of sub-graphs as 400a, 400b, 400c presents SE 1^{st} row in M(GPR) raw data matrix which is a collection of all 1^{st} A-Scan sample values i=1, with all j M(GPR[1, 1 . . . p . . . m]), that is 1^{st} SE vector of M(GPR);

A sequence of sub-graphs as 400d, 400e, 400f presents SE at intermediate some l-row in M(GPR) raw data matrix which is the collection of all i=l A-Scan samples with all M(GPR[l, 1 . . . p . . . m]), that is l-th SE vector of M(GPR);

A sequence of sub-graphs as 400g, 400h, 400j presents SE at final last n-row in M(GPR) raw data matrix which is the collection row all n-th A-Scan samples, with all M(GPR[n, 11 . . . p . . . m]), that is n-th SE vector of M(GPR);

Creating TE:

A sequence of sub-graphs as 400a, 400d, 400g presents TE 1^{st} column in M(GPR) raw data matrix which is a collection of all 1^{st} A-Scan sample values j=1, with all i M(GPR[1 . . . l . . . n, 1]), that is 1^{st} TE vector of M(GPR);

A sequence of sub-graphs as 400b, 400e, 400h presents TE at intermediate some p-column in M(GPR) raw data matrix which is the collection of all j=p A-Scan samples with all M(GPR[1 . . . l . . . n, p]), that is p-th TE vector of M(GPR);

A sequence of sub-graphs as 400c, 400f, 400j presents SE at final last m-column in M(GPR) raw data matrix which is the collection row all m-th A-Scan samples, with all M(GPR[1 . . . l . . . n, m]), that is last m-th SE vector of M(GPR);

FIG. 5 is a graph 500 of a typical shape of TECFs (Time Ensemble Correlation Functions) for a set of underground objects (metallic or vacuum cylinders)positioned along a straight line at distances of 2 (vacuum, radius r=0.08 m), 4 (perfect metal, r=0.05 m), 6 (perfect metal, r=0.055 m) and 8 m (perfect metal, r=0.08 m) from the origin. The presence, location and size of each object are detected by changes in the TECF at the location (along the x-axis).

This example corresponds to calculations based on 1-vector apart samples of the data, in accordance with an embodiment of the present invention. The detection of the presence of a free space cylinder with radius r=0.08 m at x=2 m is indicated by a changes 502 in TECF.

The detection of the presence of a perfect metal cylinder with radius r=0.05 m at x=2 m is indicated by a changes 504 in TECF. The detection of the presence of a perfect metal cylinder with radius r=0.055 m at x=6 m is indicated by a changes 506 in TECF. The detection of the presence of a perfect metal cylinder with radius r=0.08 m at x=8 m is indicated by changes 508 in TECF.

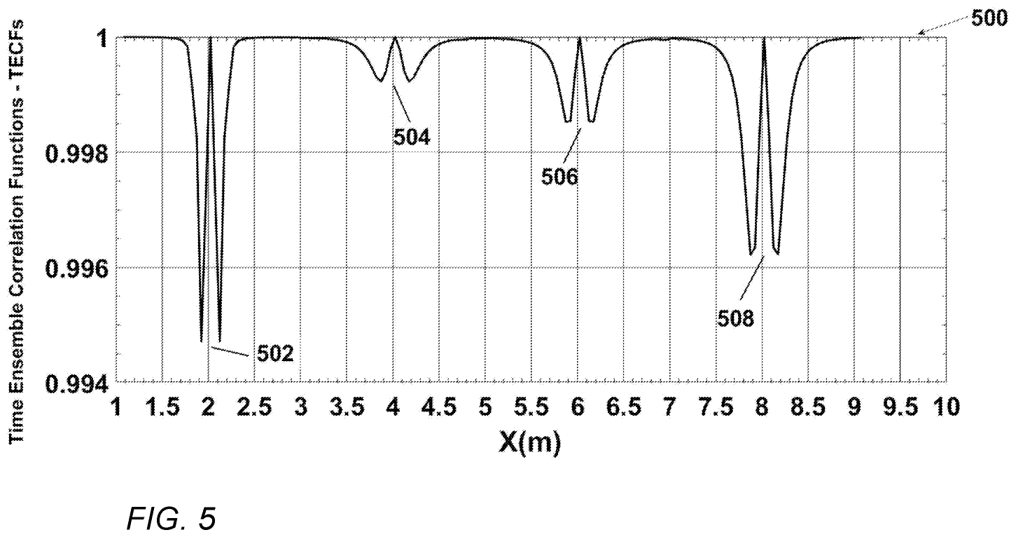

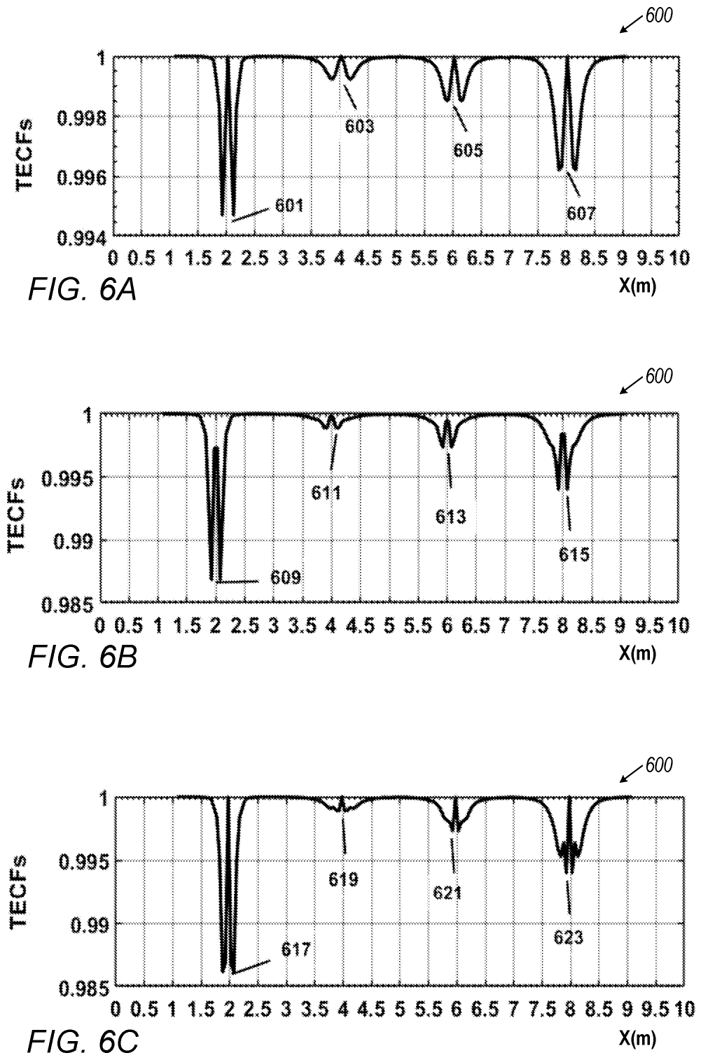

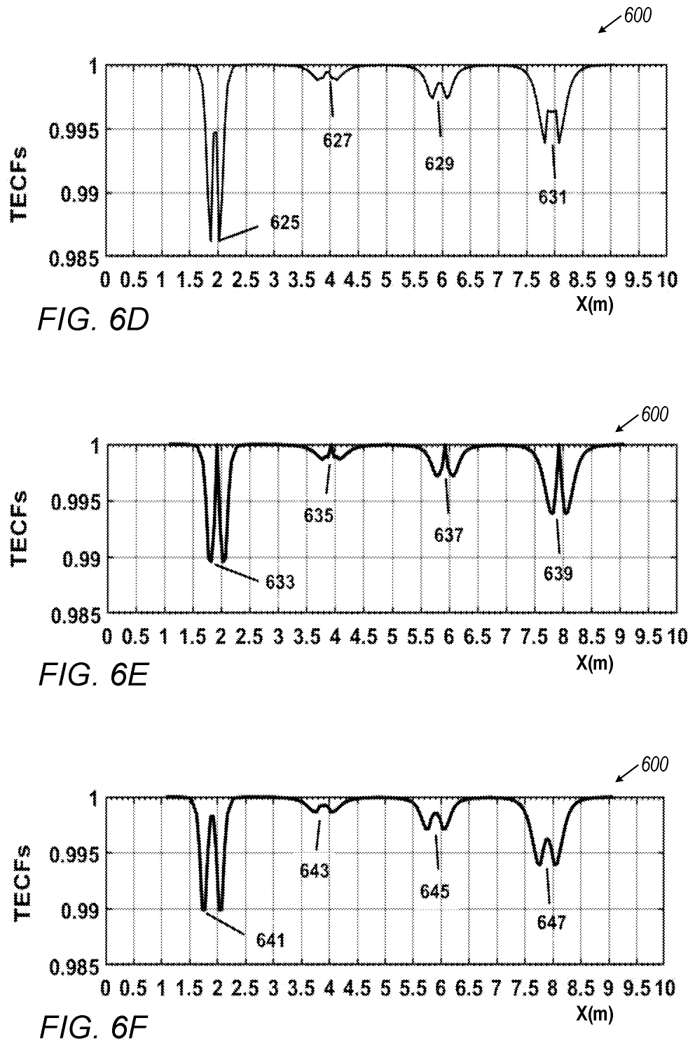

FIGS. 6A-6F comprises a set of graphs of outputs of TECFs (Time Ensemble Correlation Functions) the same as in FIG. 5 with 1-vector to 6-vectors apart between successive vectors, in accordance with an embodiment of the present invention.

In FIG. 6A to 6F, the graphs correspond to TECFs with 1-6 vectors apart, respectively. They all detect the same 4 objects. That is the drop 601 of TECF in FIG. 6A is indicative of detecting an object located around x=2 m, and in the same manner the drops 609, 617, 625, 633 and 641 in panels B-F, respectively are indicative of detecting the same object at the same location. The same is true for the other 3 objects located at distances (approximately) 4, 6.1 and 8 m.

These results are to show how in the present invention, one can use a combination of TECFs with various number of skipping vectors (number of vectors n apart) in order to improve the detectability and resolution (horizontal and vertical) of the system. In particular, this feature is very helpful for detecting small non-metallic objects under harsh conditions, when the signal to noise ratio is low. An object may be loosely allocated, say in TECFs with 1-vector apart, but may be clearly found in several vectors apart. For example, object 607 in 6A has a dip in TECFs with value greater than 0.996 and in 6E, the same object, with mark of 639, the TECFs is deeper with value at less than 0.995. In other cases, this property is crucial in finding objects in noisy environments.

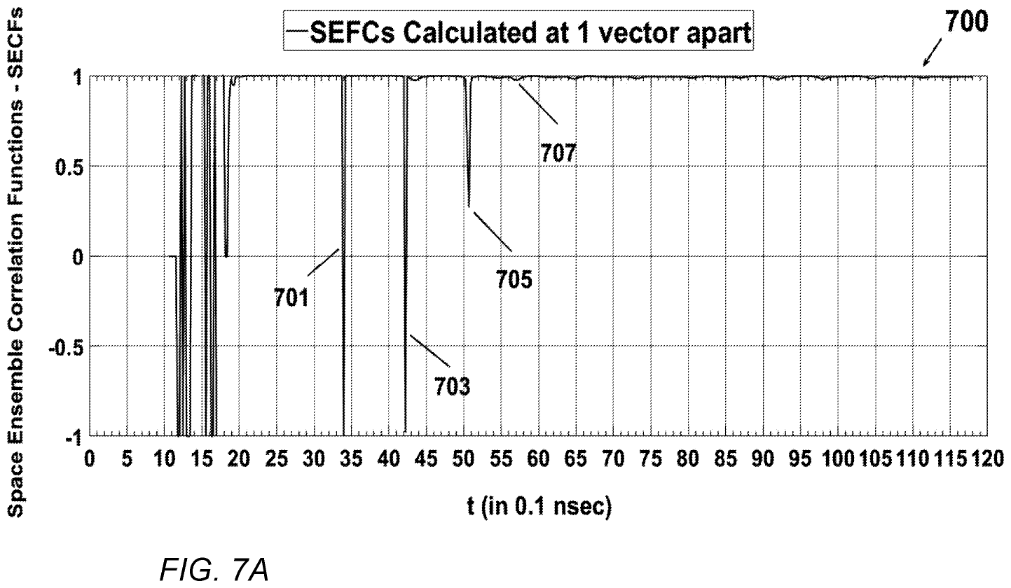

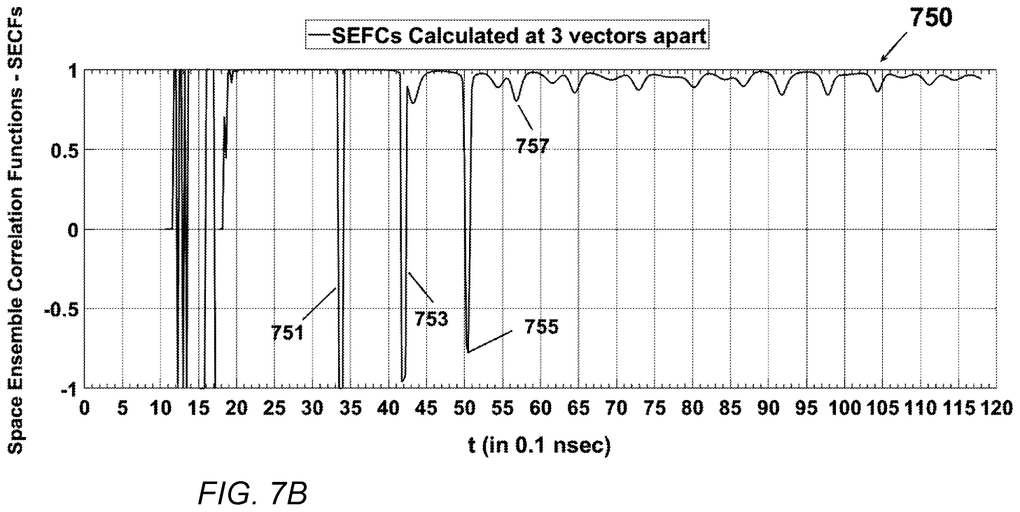

FIGS. 7A and 7B show 2 graphs 700, 750, for typical Space Ensemble correlation functions (SECFs) tools for time localization of scattered EM waves off objects with two values of SE adjacent vectors apart. FIG. 7A shows SE Correlations SECFs calculated at 1 vector apart, and FIG. 7B shows SECFs calculated at 3 vectors apart.

The detection of a void cylinder 701, located at distance 2 m is seen/indicated by a drop in SECFs (FIG. 7A) at around 3.4 n-sec. It is also seen in FIG. 7B (751) at the same time.

The detection of a PEC (perfect electric conductor) cylinder 703 located at distance 8 m is indicated by a drop in SECFs (FIG. 7A) at around 4.2 n-sec. It is also seen in FIG. 7B (753) at the same time.

The detection of a PEC cylinder 705 located at distance 6 m is seen/indicated by a drop in SECFs (FIG. 7A) at around 5.05 n-sec. It is also seen in FIG. 7B (755) at the same time.

A small drop in SECFs 709 at about 5.7 sec is a vague indicative of the presence a PEC cylinder at 4 m. This cylinder is revealed more clearly using a SECF with more vectors apart (FIG. 7B). The presence of a PEC cylinder 757 at 4 m is seen/detected at about 5.7 sec.

Applying EM wave travelling time calculations for Tx-Object to-Rx paths, support the results of SE time signals peaks, confirm the power of SE computations tool. These results show the power of the methods of the present disclosure, as they provide a high detection level, as well as and high vertical resolution, also by the change of the number skipped vectors.

Two graphs of outputs of SECFs (Space Ensemble Correlation Functions) the same as FIG. 5 with SE instead of TE results for an example base model with 1-vector to 3-vectors apart detecting EM time travel during path Tx-object-Rx for SE correlations between 1-vector to 3-vectors apart, in accordance with an embodiment of the present invention.

The presence of a void at x=2 m is seen as a sharp drop 701 and detected at 3.4 nano-seconds (nsec). The presence of a cylinder made of perfect conductor at x=8 m is seen as a drop 703 at indicated/detected at 4.2 nsec. The presence of a cylinder made of a perfect conductor at x=6 m is seen as a drop 705, as is indicated/detected at 5.05 nsec. Additionally, a weak signal for perfect electric conductor Cylinder is detected at around 5.7 nsec as a minor minimum 707 at 4 m, better revealed with more SE correlation vectors apart.

In FIG. 7B, a small minimum 709 is seen at around ˜5.7 n-sec as a signal for the PEC Cylinder at 6 m with 3 SE correlation vectors apart, corresponding to the minor minimum 707, seen in FIG. 7A. Thus, the use of several vectors apart enables better detection, per FIG. 7B than the use of 1 vector apart, as seen in FIG. 7A. Thus, better resolution and detection of underground objects is enabled using more vectors apart. These findings are important parts of the novel methods of the present invention.

Per FIG. 7B, method 750 is constructed to apply EM waves time travels calculations for Tx-Object to-Rx paths, support the results of SE time signals peaks, confirming the power of SE computation tools.

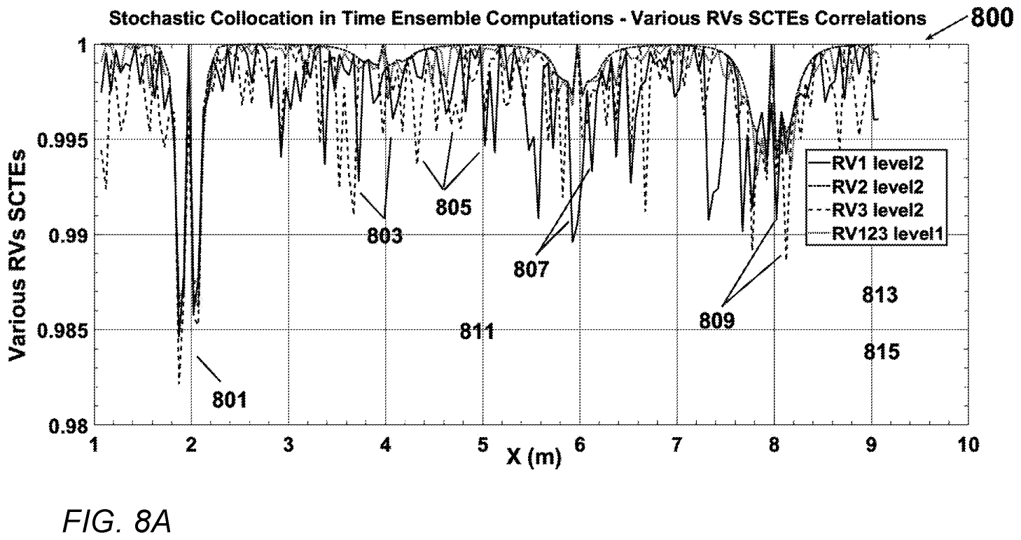

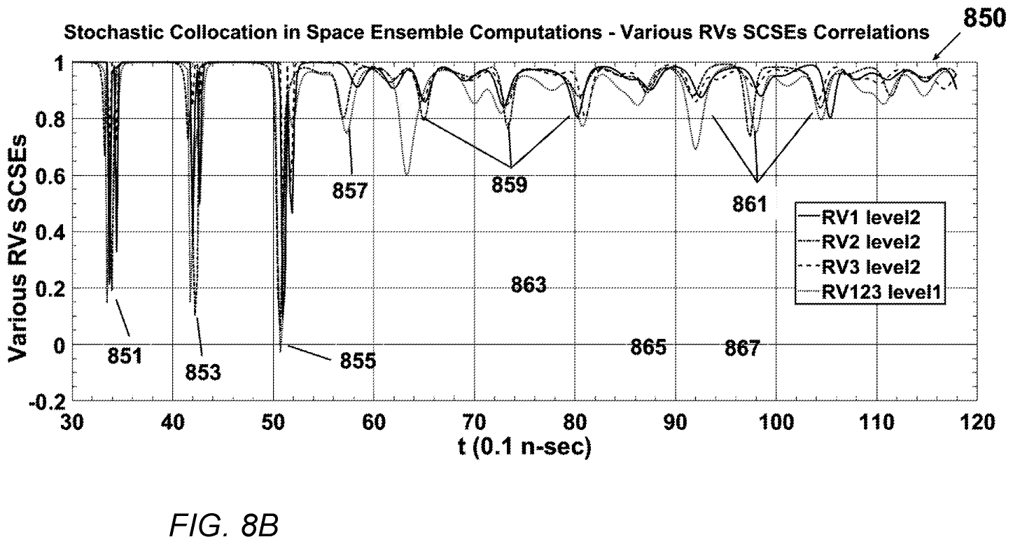

FIG. 8A is a simplified graph 800 of Stochastic Collocation in Time Ensemble Computations with various random variables (RVs) SCTEs. Correlations with the presence of noise deliberately introduced in order to show how the method performs well also under harsh conditions stemming due to presence of noise. The noise is produced by scattering and reflection of the transmitted GPR pulses by many scatterers (undesired) distributed in the underground (soil levels above and under the target objects). The impact of two noise levels are shown at a first noise level and at a second noise level, to detect underground objects at a depth coordinate (m), in accordance with an embodiment of the present invention;

The drop (dips) 801 in the SCTE at around x=2 m shows the detection of void cylinder around (depth 0.3 m from the ground surface).

A drop 803 in the SCTE at around x=4 m shows the detection of PEC cylinder around (depth 0.45 m from the ground surface).

Dips 805 in the range of 4.5-5 m in the SCTE, show multiple scattering (noise).

A drop 807 in the SCTE at around x=6 m shows the detection of a PEC cylinder around (depth 0.4 m from the ground surface). (apart in 750 graph).

A drop 809 in the SCTE at around x=8 m shows the detection of PEC cylinder around (depth 0.35 m from the ground surface).

Stochastic Collocation (SC) in TE method applying equations (23)-(24) RV1-U: ε( ); RV2-U: σ( ); RV3-U:f( ), RV123.

Stochastic Collocation (SC) in TE noise level1: RV1-U:[ε(5.6:5.7)]; RV2-U:σ(1e-6:2e-6); RV3-U:[f(498 MHz:500 MHz)] and

Stochastic Collocation (SC) in TE noise level2: RV1-U:[ε(5.6:5.9)]; RV2-U:σ(1e-6:5e-6); RV3-U:[f(495 MHz:500 MHz)].

FIG. 8B is a simplified graph 850 of Stochastic Collocation in Space Ensemble Computations with various random variables—SCSEs Correlations, at a first noise level and at a second noise level, to detect underground objects at a time coordinate (nanoseconds), in accordance with an embodiment of the present invention.

A drop (lowering) 851 in SCTE at around 3.4 nsec is indicative of the presence of a void cylinder at x=2 m.

A drop (lowering) 853 in SCTE at around 4.2 nsec is indicative of the presence of a PEC cylinder at x=8 m.

A drop (lowering) 855 in SCTE at around 5.05 nsec is indicative of the presence of a PEC cylinder at x=6 m.

The drop (lowering) 857 is SCTE at around 5.7 nsec is indicative of the presence of a PEC cylinder at x=4 m.

Scattering 859 is seen from edges of void boxes 1 and 2.

More scattering is seen.

A stochastic collocation (SC) method 863 applies equations (23)-(24) RV1-U: ε( ); RV2-U: σ( ); RV3-U:f( ); RV12.

A stochastic collocation (SC) 865 in SE noise level1: RV1-U:[ε(5.6:5.7)] RV2-U:σ(1e-6:2e-6) RV3-U:[f(498 MHz:500 MHz)].

A stochastic collocation 867 in SE noise level2: RV1-U:[ε(5.6:5.9)] RV2-U:σ(1e-6:5e-6) RV3-U:[f(495 MHz:500 MHz)].

FIG. 9A is an experimental result for TECFs between moving A-scans with 1 vector apart, used for non-metal plastic objects tracking, Applying TECFs method—finding 6 buried various plastic (non-metal) objects and other 2 effects are result of near-by metal objects aligned in parallel to plastic objects.

The deep and sharp dip 901 shows the start artifact signal of the GPR machine. The dips 903 in TECF at around x=1.7 m is indicative of detecting and localizing object 1 (plastic bag of dimensions 20 cm).

A plastic box2 905 is seen/detected at about 2.5 m from the start.

A plastic box3 907 is seen/detected at about 3.6 m from the start.

An effect 909 from land nearby metal objects, buried in parallel to a line of the plastic boxes, as above.

A plastic box4 911 is detected at about 5.3 m from the start.

A plastic box5, 913, is detected at about 8 m from the start

A plastic box 6, 915, is detected at about 8.5 m from start

An effect 917 is detected from a second line of objects, buried in parallel to the plastic boxes line. In accordance with embodiments of the present invention.

FIG. 9B is an experimental result for TECFs between moving A-scans with 2 vectors apart for Metal Objects tracking, Applying TECFs method—finding 7 buried various Metal Objects. The metal objects are found at distance from reference start point and depths in the following:

A metal object1 is placed 10 cm deep and found at 2.5 m to origin (951)

A metal object2 is placed at 15 cm deep and found 4.3 m to origin (953)

A metal object3 is placed at 20 cm deep and found at 5.7 m to origin (955)

A metal object4 is placed at 10 cm deep and found at 7.3 m to origin (957)

A metal object5 is placed at 15 cm deep and found at 9.4 m to origin (959)

A metal object6 is placed at 10 cm deep and found at 10.6 m to origin (961)

A metal object7 is placed at 25 cm deep and found at 12 m to origin (963),

in accordance with embodiments of the present invention.

In FIG. 9A and FIG. 9B experiment results a GPR pulse at 3200 MHz was transmitted from the system of FIG. 1A into a ground area under test. The plurality of reflected pulse/signals were received and recorded. The following data of the measuring device features and data collection info are: time window: 68.75 nsec, antenna separation: 0.18 m, sampling distance interval: 0.008651 m, scanning length: 12.5 m, number of time samples for each A-Scan: 220, number of traces: 1446. An output matrix was organized, as is explained with respect to step 202 (FIG. 2). The method of FIG. 2 was performed. Per step 206, graphs were generated from TECFs.

These are be seen in FIGS. 9A and 9B (one and multiple (two)) vectors apart. As can be seen from FIG. 9B for metal objects detection, at a distance of 2.4-2.5 m, the TECFs shows a sharp first non-false dip (951), indicative of an object being present, and so on. FIG. 9C schematically shows the metal objects (and their FIG. 9B locations) 971 (951), 973 (953), 975 (955), 977 (957), 979 (959), 981 (961) and 983 (963), as buried under the ground (at a depth of 10 cm to 25 cm).

### I (a) Examples of Measurements Systems

A variety of GPR measurement systems can use the proposed method either incorporated in the system as add-on or as a fitted specific external supplementary tool. These types of machines satisfy demands in sectors such as those listed in Tables 1-4 below found in ref. (1):

### I (b) Examples of Simulation Systems

A variety of GPR simulation platforms can use the proposed method either incorporated in the system software algorithm as internal add-on or as direct subsequent external supporting tool. These types of software package work as accompanying measure to field measurements of experimental lab systems for variety of demands. Some of them cover broad applications, such as gprMax in ref. (2), other are used for multipurpose GPR survey in ref. (3), other directed to dedicated application such as road scanners for under road structure in ref (4), or a software for GPR training system in ref (5), software package that uses other mathematical platform such as Matlab as a base in ref. (6), etc.

A GPR system 1 according to one embodiment of the present invention is shown in FIG. 1A.

Accordingly, it is an object of the present invention to provide an efficient method which enroll statistical tools that determine with high certainty the allocation of buried objects in the underground that are targeted at obscured positions with non-exact finding in space and time.

This invention shows how to employ generated GPR raw data gained by transmitter-receiver pair antennas of several A-scans of the underground, known as B-scan performance, gives rise to exact allocation of underground objects both in space and time in high precision.

According to a further feature of the present invention the following steps have been devised to set up the proposed innovation:
1. Establish the mathematical formalistic layout to create statistical buildup ensembles out of any GPR raw data input, either measured or simulated; (a) Space Ensemble (SE), (b) Time Ensemble (TE) and characterize them as SE and TE Stochastic Processes (SP). While TE reflects SP causal sequence of events, SE portrayed non-causal SP extended over space at selected instances in time.
2. Generate formulations for SE and TE with proper statistic ensembles of variables that give insight on the process of the advancing Electromagnetic (EM) fields. These EM fields are emitted from a transmitting antenna Tx propagating throughout a tested underground medium, encountering scattering objects or other discontinuities and the boundaries of the targeted enclosure, reflected back to the receiver Rx.
3. Derive statistic equations for SE-SP and TE-SP for their normalized variables of the EM fields; (1) Expectation Values (Averages), (2) Standard Deviations (std), (3) Variances, (4) Correlation Functions.
4. Two groups of correlation function are created; Space Ensemble Correlation Functions (SECFs) and Time Ensemble Correlation Functions (TECFs). These SECFs and TECFs plays innovative role in determining with high accuracy of underground objects both in space via TECFs along the underneath the line of B-scan, and in time via SECFs pointing to the exact times of the scattering events of the scattered EM fields by objects.
5. SECFs and TECFs are taken between their inner mutual ensemble pairs of vectors, between closely adjoins pairs at one vector apart (that is between a vector and the immediate next to it), or between close other pairs such as 2 vectors apart (that is between a vector and the second next to it), or 3 vectors apart (that is between a vector and the third next to it), and so on. This tool gives rise to a process that gives assumption about the size of an underground object. At certain pairing, correlations are lost, meaning the correlations are lost, giving an estimation of the size of an object, e.g. by TECFs.
6. Extend the establish the mathematical formalistic layout to create Stochastic Collocations on top of the statistical buildup ensembles out of any GPR raw data input, either measured or simulated; (a) Stochastic Collocation of Space Ensemble (SC-SE), (b) Stochastic Collocation of Time Ensemble (SC-TE), and characterize them as SC-SE and SC-TE Stochastic Collocation for Sensitivity Analysis (SA). SC-TE reflects range of randomness in physical properties during time causal sequence of events, SC-SE reflects range of randomness in physical properties along line space of non-causal events perturbed over space at selected instances in time according to advancing A-scan along line.
7. Two groups of stochastic collocation correlation functions are created; Stochastic Collocation Space Correlations (SC-SEs) and Stochastic Collocation Time Ensemble (SC-TEs). These SC-SEs and SC-TEs enable Sensitivity Analysis of the data gained in the non-perturbed SECFs and TECFs in imitating and fitting the ground physical parameters in effort to match better actual ground properties and optimizing the finding of scattering events of the EM fields by objects and structure.
1. An embodiment, a method of devising statistic ensembles from Ground Penetration Radar (GPR) raw data matrix n×m, e.g. G_{Tx,Rx}^{i,j}(\vec{r}, t, n, m), of Electro-Magnetic (EM) waves from a Transmitter Tx with large number m of A-scans (denoted as B-scan) during scan time t of choice for each A-scan, sampled n times at a Receiver Rx, measured or simulated, a Space Ensemble (SE) and Time Ensemble (TE) organized as primitive statistic groups for valid statistical analysis.
2. An embodiment of generating proper statistic ensembles for GPR raw data matrix, e.g. G_{Tx,Rx}^{i,j}(\vec{r}, t, n, m) (i-row in n, j-column in m), for Electric (E) and/or Magnetic (M) fields, their Amplitudes, their Square Amplitudes and higher orders of (E, M) fields that are weighted and normalized to address standard statistic group requirements.
3. An embodiment of grouping a proper statistic Space Ensemble (SE) from GPR raw data matrix, e.g. G_{Tx,Rx}^{i-fixed,j}(\vec{r}, t, n, m), for Electric (E) and/or Magnetic (M) fields, of embodiment 2, taking each row of any i-fixed as a fully valid statistical vector. SE encompasses non-causal space-vector, a process of tailoring subsequent A-traces within B-scan. All G_{Tx,Rx}^{i-fixed,j}(\vec{r}, t, n, m) for all i=(1 . . . n) generated Stochastic Process Space Ensemble SP-SE vectors group. Support the allocation of objects at their times of scatterings.
4. An embodiment of grouping a proper statistic Time Ensemble (TE) from GPR raw data matrix, e.g. G_{Tx,Rx}^{i,j-fixed}(\vec{r}, t, n, m), for Electric (E) and/or Magnetic (M) fields, of embodiment 2, taking each column of any j-fixed as a fully valid statistical vector. TE encompasses causal time-vector, a process of tailoring subsequent Rx samplings within j-th A-scan. All G_{Tx,Rx}^{i,j-fixed}(\vec{r}, t, n, m) for all j=(1 . . . m) generated Stochastic Process Time Ensemble SP-TE vectors group. Support the allocation of objects at their locations of scatterings.
5. An embodiment of buildup of mathematical formulation of statistic functions: (1) Expectation Values (Averages), (2) Standard Deviations (STD), (3) Variances, (4) Correlation Functions. Apply for Space Ensemble (SE) vectors in G_{Tx,Rx}^{i-fixed,j}(\vec{r}, t, n, m). All correlation functions for G_{Tx,Rx}^{i-fixed,j}(\vec{r}, t, n, m) with pairs among i=(1 . . . n) generate Space Ensemble Correlation Functions SECFs. A one SE vectors apart up to several vectors apart between vector-pairs are tools for the allocation of objects at their times of scatterings at various levels of allocation from the various scattering points off an allocated object.
6. An embodiment of buildup of mathematical formulation of statistic functions: (1) Expectation Values (Averages), (2) Standard Deviations (STD), (3) Variances, (4) Correlation Functions. Apply for Time Ensemble (TE) vectors in G_{Tx,Rx}^{i,j-fixed}(\vec{r}, t, n, m). All correlation functions for G_{Tx,Rx}^{i,j-fixed}(\vec{r}, t, n, m) with pairs among j=(1 . . . m) generate Time Ensemble Correlation Functions TECFs. A one TE vectors apart up to several vectors apart between vector-pairs are tools for the allocation of objects at their space points of scatterings at various levels of allocation while increasing the separation between correlated vectors leads to diminished correlation giving an idea of the size of the scattering object.
7. An embodiment that extends the 1-6 embodiments of the non-perturbed mathematical formalism layout for creating Stochastic Collocations on top of the statistical buildup ensembles out of any GPR raw data input, either measured or simulated; This produces (a) Stochastic Collocation of Space Ensemble (SC-SE), and (b) Stochastic Collocation of Time Ensemble (SC-TE) which enable a variety of Sensitivity Analysis (SA).

8. An embodiment for SC-SE and SC-TE that is formulated by the introduction of by Random Values (RVs) via a statistical g(ω). All expressions of the non perturbed correlation functions, SE-G_{Tx,Rx}^{i-fixed,j}(\vec{r}, t, n, m) and TE-G_{Tx,Rx}^{i-fixed,j}(\vec{r}, t, n, m) are weighted in a stochastic collocation processes by Random Values (RVs) of physical parameters of interest by fitted random functions, say in general g(ω)for any element in the group of probably distribution functions (PDFs)g(ω), ω∈Ω is given formally by:

E{g(Ω)}=Σᵢ₌₀ⁿωᵢ·G_{Tx,Rx}^{i-fixed,j}(\vec{r}, t, n, m) SC-SE

E{g(Ω)}=Σᵢ₌₀ⁿωᵢ·G_{Tx,Rx}^{i,j-fixed}(\vec{r}, t, n, m) SC-TE

### I. Computer Program Application

The raw data generated by Ground Penetrated Radar (GPR) with the System during B-scan either in any method of known or future established method of measurement or may be created by GPR simulations by any current method or future devised method of simulation can simply turn the mathematical formulation proposed in the documents titled:
(1) “Stochastic Processes Approach in GPR Applications” and
(2) “Stochastic Collocation Introduction into Correlation Functions Method used for Ground Objects Detection”
   can directly written as a computer program by any known method, such the languages C, C++, Matlab, python, etc. or by any future established computer program.
   The principle for applying the proposed method is as follows:
(1) Measure or Simulate the targeted desired model in B -scan with sufficiently numerous A-scans→
(2) Collected GPR raw data matrix from step (1)→
(3) Run the devised algorithm with the input of step (2) to allocate underground object in space allocation using TECFs(correlating successive matrix columns) and underground depth allocation using SECFs (correlating successive matrix rows).

### SOME EMBODIMENTS OF THE PRESENT INVENTION

1. A method to provide an efficient apparatus to enroll statistical tools that determine with high certainty the allocation and detection of buried objects in the underground, or the forms of structures, or buildings, or archeological remains, or agriculture underground elements, or search for minerals of all types, or for road paths build or maintenance, or any else type of underground search that are targeted at obscured positions or unknown, or other forms with non-exact finding in space and time.
1.1. The method employs generated Ground Penetration Radar (GPR) raw data gained by transmitter-receiver pair antennas of several A-scans of the underground, known as B-scan performance, gives rise to exact allocation of underground objects both in space and time in high precision.
1.1.1. Any raw data origin or source can be used in 1.1. in any dimensionality, 2D, 3D, etc. as matrix of space-time e.g.
(a) Measurements
(b) Simulations
(c) Calculated directly by existing or new GPR theoretical models
(d) Artificially built
1.1.2. Any measuring device in 1.1.1(a) whom output is in the form of raw data matrix of space-time can be used in Embodiment 1. Examples of types of the measuring devices are listed in Tables 1-4 in “I (a) Examples of Measurements Systems” and also any devices that exist or will be available in the market or research field's devices or any other types. The measuring device may be mounted on any platform; mobile, flown, penetrating underground, or any existing or future mode.
1.1.3. Any suitable transmitter-receiver pair of antennas in the form of dipole, horn, etc. and any other type of configuration of pair of antennas can be used in suitable arrangement appropriately for the featured required for employing 1.1.2. to serve as tool for in 1.1.1(a) may apply for Embodiment 1.
1.1.4. Any existing simulation tool or simulation that will be produced in the future, that is used as a form of 1.1.1 (b) for the purpose of generating output is in the form of raw data matrix of space-time of 1.1.1 can be used in Embodiment 1. Examples of types of the simulation tools are listed in “I (b) Examples of Simulation Systems” and in its reference list and can be found elsewhere.
1.1.5. Multiple A-scan as B-scan can be performed employing one or more of the 1.1.1. options for 1.1. header description in line, or simultaneous multiple lines or any form that creates data matrix of space-time for the purpose of Embodiment 1 performance.

### Embodiment 2

1. A method of detecting underground objects as defined in Embodiment 1, and further comprising of establishing mathematical formalistic layout to create statistical buildup ensembles out of any GPR raw data input in Embodiment1, 1.1., either measured or simulated or any method in Embodiment 1, 1.1.1.; wherein the steps to build (a) Space Ensemble (SE), (b) Time Ensemble (TE) and characterize them as SE and TE Stochastic Processes (SP) (or comprising of any combination of SE and TE with otherwise than simplistic statistical methods of correlation functions that gives improvements results for Embodiment 1.). While TE reflects Stochastic Process (SP) causal sequence of events, SE portrayed non-causal SP extended over space at selected instances in time.
2. For the establishment of Embodiment 2.1. generate formulations for SE and TE (or comprising of any combination of SE and TE with otherwise than simplistic statistical methods of correlation functions that gives improvements results for Embodiment 1.) with proper statistic ensembles of variables that give insight on the process of the advancing Electromagnetic (EM) fields. These EM fields are emitted from a transmitting antenna Tx as in Embodiment 1. 1.1.3. propagating throughout a tested underground medium, encountering scattering objects or other discontinuities and the boundaries of the targeted enclosure, reflected back to the receiver Rx as in Embodiment 1. 1.1.3.
3. For the establishment of Embodiment 2.2. wherein the next step includes the derivation of statistical equations for SE-SP and TE-SP for their normalized variables of the EM fields; (1) Expectation Values (Averages), (2) Standard Deviations (std), (3) Variances, (4) Correlation Functions (or comprising of any combination of SE and TE for steps (1)-(4) with otherwise than simplistic statistical methods of correlation functions that gives improvements results for Embodiment 1.).
4. For the establishment of Embodiment 2.3. wherein the next step includes the derivation of statistical equations for SE-SP and TE-SP for their normalized variables of the EM fields; (1) Expectation Values (Averages), (2) Standard Deviations (std), (3) Variances, (4) Correlation Functions (or comprising of any combination of SE-SP and TE-SP for computing (1)-(4) with otherwise than simplistic statistical methods of correlation functions that gives improvements results for Embodiment 1.).
5. For the establishment of Embodiment 2.4., wherein the next step includes the derivation of statistical equations for creating two groups of correlation functions; Space Ensemble Correlation Functions (SECFs) and Time Ensemble Correlation Functions (TECFs). These SECFs and TECFs plays innovative role for Embodiment 1. in determining with high accuracy the detection of underground objects both in space via TECFs along the underneath the line of B-scan, and in time via SECFs pointing to the exact times of the scattering events of the scattered EM fields by objects (or comprising of any otherwise than simplistic statistical methods of correlation functions, that gives improvements results for computing equivalent function to the defined Space Ensemble Correlation Functions (SECFs) and Time Ensemble Correlation Functions (TECFs) for computing Embodiment 1.).
6. For the establishment of Embodiment 2.5. wherein the next step includes the derivation of statistical equations where SECFs and TECFs are taken between their inner mutual ensemble pairs of vectors, between closely adjoins pairs at one vector apart (that is between a vector and the immediate next to it), or between close other pairs such as 2 vectors apart (that is between a vector and the second next to it), or 3 vectors apart (that is between a vector and the third next to it), and so on. This tool gives rise to a process that gives assumption about the size of an underground object. At certain pairing, correlations are lost, meaning the correlations are lost, giving an estimation of the size of an object, e.g. by TECFs, (or comprising of any otherwise than simplistic statistical methods of correlation functions as in Embodiment 2.5.

alternative that gives improvements results for computing equivalent results in employing this method between several vectors apart, or between their equivalents, for improving results for Embodiment 1.).
7. For the establishment of Embodiment 2.1.-2.6. wherein another step for broadening the method for the derivation of Embodiment 1. includes the extending the of establishment of the mathematical formalistic layout in Embodiment 2.1-2.6 to create Stochastic Collocations on top of the statistical buildup ensembles out of any GPR raw data input as in Embodiment 1., either measured or simulated or any other way in Embodiment 1.1.1; (a) Stochastic Collocation of Space Ensemble (SC-SE), (b) Stochastic Collocation of Time Ensemble (SC-TE), and characterize them as SC-SE and SC-TE Stochastic Collocation for Sensitivity Analysis (SA). SC-TE reflects range of randomness in physical properties during time causal sequence of events, SC-SE reflects range of randomness in physical properties along line space of non-causal events perturbed over space at selected instances in time according to advancing A-scan along line or otherwise (wherein this works for comprising any otherwise than simplistic statistical methods of correlation functions as in Embodiment 2.1-2.6. alternative that gives improvements results for computing equivalent results in employing this method for the derivation of SC-SE and SC-TE or their equivalents for improving results for Embodiment 1.).
8. For the establishment of Embodiment 2.7. wherein another step for broadening the method for the derivation of Embodiment 1. two groups of stochastic collocation correlation functions are created; Stochastic Collocation Space Correlations (SC-SEs) and Stochastic Collocation Time Ensemble (SC-TEs). These SC-SEs and SC-TEs enable Sensitivity Analysis of the data gained in the non-perturbed SECFs and TECFs in Embodiments 2.1-2.6 in imitating and fitting the ground physical parameters in effort to match better actual ground properties and optimizing the finding of scattering events of the EM fields by objects and structure (wherein this, works for comprising any otherwise than simplistic statistical methods of correlation functions as in Embodiment 2.1-2.6. alternative that gives improvements results in Embodiment 2.7. as Sensitivity Analysis (SA) for computing equivalent results in employing this method for the derivation of SC-SEs and SC-TEs for SA in or their equivalents for improving results for Embodiment 1.).

### NEW SYSTEM

### Embodiment 3

1. All existing hardware systems for the NEW SYSTEM apply for Embodiment 1.1.1.(a) or future invented, produced, or otherwise, that collect Ground Penetration Radar (GPR) as raw data, or otherwise, that fit as input for the method in Embodiment 1. and used in Embodiment 2. that can utilize Embodiment 1. and Embodiment 2. for the derivation of Embodiment 1.1., which apply the NEW METHOD by incorporating the NEW METHOD into the hardware, or chained used (or otherwise) in post measurements operation for the NEW METHOD with the derived GPR data, or in otherwise utilization of the NEW METHOD, in any step for the purpose of detection of underground objects or structures, or any else search, as in Embodiment 1.1. Any measuring device in 1.1.2 whose output is in the form of raw data matrix of space-time can be used in Embodiment 1. Examples of types of the measuring devices are listed in Tables 1-4 in “I (a) Examples of Measurements Systems” and also any devices that exist, or will be available in the market, or research field's devices or any other types. The measuring device may be mounted on any platform; mobile, flown, penetrating underground, or any existing or future mode.
2. All existing simulation tools, or simulation methods apply for Embodiment 1.1.1.(b) or future invented, produced, or otherwise, that simulate Ground Penetration Radar (GPR) produce raw data matrix of space-time of 1.1.1, or otherwise, are part of NEW SYSTEM the that fit as input for the NEW METHOD in Embodiment 1. and used in Embodiment 2. that can utilize Embodiment 1. and Embodiment 2. for the derivation of Embodiment 1.1. of NEW METHOD. Examples of types of the simulation tools are listed in “I (b) Examples of Simulation Systems” and in its reference list and can be found otherwise elsewhere.
3. All GPR theoretical models that calculate directly, or otherwise, by existing or new, theoretical methods, that apply for the creation of raw data, or otherwise, in the form of Embodiment 1.1.1.(c), or future invented, produced, or otherwise, that produce Ground Penetration Radar (GPR) raw data matrix of space-time of 1.1.1, or otherwise, are part of NEW SYSTEM that fit as input for the NEW METHOD in Embodiment 1. and used in Embodiment 2. that can utilize Embodiment 1. and Embodiment 2. for the derivation of Embodiment 1.1. for the NEW METHOD. Examples of types of raw data that are calculated directly from GPR theoretical models can be found otherwise elsewhere.
4. All artificially built GPR raw data by any approach, accumulated mechanically, built from crossover data sources, one source, tailored, mixed, or otherwise, that apply for the creation of raw data, or otherwise, in the form of Embodiment 1.1.1.(d), or future invented, produced, or otherwise, that produce Ground Penetration Radar (GPR) raw data matrix of space-time of 1.1.1, or otherwise, are part of NEW SYSTEM that fit as input for the NEW METHOD in Embodiment 1. and used in Embodiment 2. that can utilize Embodiment 1. and Embodiment 2. For the derivation of Embodiment 1.1. For the NEW METHOD. Examples of types of raw data that are artificially built directly from GPR raw data gathering can be found otherwise elsewhere.
   What is desired to be protected by Letters Patent is set forth in particular in the appended claims.

### REFERENCES

(1) Zhongming Xiang, S.M.ASCE1; Abbas Rashidi, M.ASCE; and Ge “Gaby” Ou, Aff.M.ASCE, “States of Practice and Research on Applying GPR Technology for Labeling and Scanning Constructed Facilities”, J. Perform. Constr. Facil., 2019, 33(5): 03119001.
(2) C. Warren, A. Giannopoulos, I. Giannakis, “ Gprmax: Open Source Software to Simulate Electromagnetic Wave Propagation for Ground Penetrating Radar.”Comput. Phys. Commun. 2016, 209, 163-170. https ://doi.org/10.1016/j.cpc.2016.08.020 [CrossRef]
(3) GPRSIM v3.0 Software (c1992-) Ground Penetrating Radar Simulation Software, https://www.gpr-survey.com/gprsim.html, https://www.gpr-survey.com/index.html Road scanners Inc., “Road Doctor™ Software Version 3, https://www.roadscanners.com/products/software-products/road-doctor/.
(4) Decipher GPR training system, https://www.decifergpr.com/the-software.
(5) MatGPR 3.5, http://users.uoa.gr/-atzanis/matgpr/matgpr.html.
(6) Haridim, M., & Zemach, R. (2021). Stochastic Processes Approach in GPR Applications. IEEE Transactions on Geoscience and Remote Sensing.
(7) “Zemach, R., &Haridim, M. (2021). Stochastic Collocation Introduction Into Correlation Functions Method Applied for Underground Objects Detection. IEEE Transactions on Geoscience and Remote Sensing

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1-34. (canceled)

35. A method for detecting an object, the method comprising the steps of:
applying a plurality of electromagnetic pulses of a ground penetrating radar to a location of interest;
receiving a plurality of reflected electromagnetic pulses by said ground penetrating radar as a raw data;
organizing the raw data as sequential time ensembles and sequential space ensembles;
forming a first output matrix by:
calculating first time ensemble correlation functions between time ensembles having a distance of one vector apart;
calculating first space ensemble correlation functions between sequential space ensembles having a distance of one vector apart;
organizing the time ensemble correlation functions and space ensemble correlation functions into a first output matrix where the sequential time ensemble correlation functions are in a first column dimension and sequential space ensemble correlation functions are in a second row dimension;
forming multiple subsequent output matrices by assigning a sequence number (n) vectors apart to the output matrix:
calculating time ensemble correlation functions between time ensembles having a distance of the sequence number (n) vectors apart;
calculating space ensemble correlation functions between sequential space ensembles having a distance of the sequence number (n); and
applying a functions change sensitivity method between the first output matrix and any of the subsequent output matrices, while increasing the distance between time ensembles and space ensembles by sequence number (n) vectors apart until the correlations are lost,
thereby detecting the presence, size, and location of an object shown by changes in the correlation functions.

36. A method according to claim 35, wherein the step of organizing the raw data comprises calculating at least one of the group comprising Expectation Values, Standard Deviations and Variances.

37. A method according to claim 35, wherein the space ensemble data is obtained from a position information of the ground penetrating radar.

38. A method according to claim 35, wherein the time ensemble data is obtained from the reflected electromagnetic pulses from the objects.

39. A method according to claim 35, further comprising using the ground penetrating radar to detect an underground or an underwater object.

40. A method according to claim 39, further comprising using the ground penetrating radar to detect a non-metallic object.

41. A method according to claim 39, wherein said object comprises plastic, rubber, wood, mammalian tissue, cloth, vegetable matter, mineral matter, animal matter, and combinations thereof.

42. A method according to claim 35, wherein for applying a plurality of electromagnetic pulses, the ground penetrating radar is attached to a land vehicle, an aquatic vehicle, or an airborne vehicle.

43. A method according to claim 42, wherein the ground penetrating radar is attached to an airborne vehicle, and wherein the airborne vehicle is a drone.

44. A radar, comprising:
a transmitter configured to transmit a plurality of electromagnetic pulses to a location of interest;
a receiver configured to receive a plurality of reflected electromagnetic pulses a raw data;
a processor adapted to organize the raw data as sequential time ensembles and sequential space ensembles;
form a first output matrix by:
calculating first time ensemble correlation functions between time ensembles having a distance of one vector apart;
calculating first space ensemble correlation functions between sequential space ensembles having a distance of one vector apart;
organizing the time ensemble correlation functions and space ensemble correlation functions into a first output matrix where the sequential time ensemble correlation functions are in a first column dimension and sequential space ensemble correlation functions are in a second row dimension;
forming multiple subsequent output matrices by assigning a sequence number (n) to the output matrix:
calculating time ensemble correlation functions between time ensembles having a distance of the sequence number (n) vectors apart;
calculating space ensemble correlation functions between sequential space ensembles having a distance of the sequence number (n) vectors apart; and
applying a functions change sensitivity method between the first output matrix and any of the subsequent output matrices, while increasing the distance between time ensembles and space ensembles until the correlations are lost,
thereby detecting the presence, size and location of an object shown by changes in the correlation functions at the detected time and space.

45. A radar according to claim 44, wherein the radar is a ground penetrating radar configured to detect an underground object.

46. A radar according to claim 44, wherein the radar is configured to detect an underwater object.

47. A radar according to claim 44, wherein the radar is attached to a land vehicle, an aquatic vehicle, or an airborne vehicle.

48. A radar according to claim 47, wherein the radar is attached to an airborne vehicle, and wherein the airborne vehicle is a drone.

49. A computer program product comprising a computer-readable storage medium having instructions recorded thereon for enabling a processor-based system to perform operations, the operations comprising:
receiving, as a raw data, a plurality of reflected electromagnetic pulses from a ground penetrating radar having applied a plurality of electromagnetic pulses of to a location of interest;
organizing the raw data as sequential time ensembles and sequential space ensembles;
forming a first output matrix by:
calculating first time ensemble correlation functions between time ensembles having a distance of one vector apart;
calculating first space ensemble correlation functions between sequential space ensembles having a distance of one vector apart;
organizing the time ensemble correlation functions and space ensemble correlation functions into a first output matrix where the sequential time ensemble correlation functions are in a first column dimension and sequential space ensemble correlation functions are in a second row dimension;
forming multiple subsequent output matrices by assigning a sequence number (n) to the output matrix:
calculating time ensemble correlation functions between time ensembles having a distance of the sequence number (n) vectors apart;
calculating space ensemble correlation functions between sequential space ensembles having a distance of the sequence number (n) vectors apart; and
applying a functions change sensitivity method between the first output matrix and any of the subsequent output matrices, while increasing the distance between time ensembles and space ensembles until the correlations are lost, thereby detecting the presence, size and location of an object shown by changes in the correlation functions.
